(19) United States
(12) Patent Application Publication
(10) Pub. No.: US 2025/0334084 A1
(43) Pub. Date: Oct. 30, 2025

(54) DRIVELINE FOR DECOUPLING AN ENGINE FROM A LOAD

(71) Applicant: Transmission CVTCorp Inc., Sainte-Julie (CA)

(72) Inventor: Daniel Girard, St-Mathieu-de-Beloeil (CA)

(21) Appl. No.: 19/194,629

(22) Filed: Apr. 30, 2025

Related U.S. Application Data
(60) Provisional application No. 63/640,583, filed on Apr. 30, 2024.

(51) Int. Cl. F02D 41/02

(52) U.S. Cl. CPC F02D 41/024; F02D 41/0225; F02D 2041/026

(57) ABSTRACT

A driveline includes an engine system including an engine, the engine having an output shaft. The driveline further includes a gearbox having a gearbox input connected with the output shaft of the engine and a gearbox output, and an equipment including a load, the load having a load input connected with the gearbox output. The driveline further includes a controller in communication with the engine system, gearbox and equipment. The controller is configured to adjust one or more operating conditions of one or more of the engine system, gearbox, and equipment to satisfy one or more control objectives.

### CROSS REFERENCE TO RELATED APPLICATIONS

The application claims priority to and the benefit of U.S. Provisional Patent Application No. 63/640,583, filed on Apr. 30, 2024, entitled “DRIVELINE FOR DECOUPLING AN ENGINE FROM A LOAD”, which we incorporate by reference in its entirety.

### FIELD

An apparatus for decoupling an engine from a load, and in particular, a driveline for decoupling an engine from a load to control and optimize the combustion and anti-pollution system of the engine.

### BACKGROUND

The following paragraphs are provided by way of background. They are not, however, an admission that anything discussed therein is prior art or part of the knowledge of persons skilled in the art.

In an effort to be more environmentally conscious, as well as to meet emissions rules, engine manufacturers have developed highly sophisticated emission control systems (i.e., aftertreatment systems). These anti-pollution systems, including their efficiency, are largely influenced by the use of the engine. Of particular importance are the torque and speed applied to the engine.

An engine may run at different speeds. For a diesel engine, typical speeds range from about 600 RPM to 2500 RPM. An engine may also have different torques. The available torque depends on the speed of the engine. The power provided by the engine is the combination of the engine speed and engine torque. For example, an engine operating at a torque T and a speed S would produce the same power when operating at a torque of 0.5*T and a speed of 2*S.

An engine that powers a load (e.g., a pump, generator, vehicle, etc.) is usually controlled by speed. The equipment controller or the driver will command a certain rotational speed to the engine. Engine torque is load-dependent and varies greatly (e.g., it may be virtually non-existent or very high).

The operating conditions of the engine (e.g., torque produced and speed) have a direct impact on several engine factors, including combustion temperature, mass air flow, and combustion efficiency (including the presence of unburned fuel in the exhaust gases and other pollutants such as NOx). An engine that operates under good operating conditions will generate enough heat for the engine after-treatment system to be effective.

The operation of an engine at low torque and/or low load can create many issues, including inefficient and incomplete combustion. This mode of operation also has low exhaust temperatures, making emission control systems ineffective. Soot production is increased while NOx and CO emissions are not treated. The accumulated soot tends to block the anti-pollution system. Prolonged low-load operation will create bore glazing, which will make the engine burn lubricating oil. This phenomenon amplifies soot accumulation and anti-pollution system blocking. The engine will then require a regeneration, which usually involves the injection of fuel into the exhaust and/or creating restrictions and or the addition of an artificial load to increase the temperature. In cases where regeneration does not work and soot continues to accumulate, the engine will force a standstill regeneration. The standstill regeneration forces the equipment to stop operating, and the engine will begin a cleaning cycle to burn off the residue in the emission control system.

In addition, low exhaust temperature operation prevents the injection of urea (exhaust fluid), which can crystallize over time in the system and lead to breakage if operated at low temperature for too long. A technician will then be needed to repair or replace the affected parts.

Therefore, although the engine can operate at any speed and torque, certain operating conditions must only be temporary in order to avoid: (i) over-consumption of fuel; (ii) premature part breakages; and (iii) causing the anti-pollution system to become ineffective.

Accordingly, it is required to avoid operating for long periods under adverse operating conditions. In particular, a need exists to decouple the engine from the load without affecting the equipment.

### SUMMARY

According to one broad aspect of the teachings herein, in at least one embodiment described herein there is provided driveline including: an engine system including an engine, the engine having an output shaft; a gearbox having a gearbox input connected with the output shaft of the engine and a gearbox output; an equipment including a load, the load having a load input connected with the gearbox output; and a controller in communication with the engine system, gearbox and equipment, the controller configured to adjust one or more operating conditions of one or more of the engine system, gearbox, and equipment to satisfy one or more control objectives.

In at least one embodiment, the one or more operating conditions of the engine system includes the speed of the engine.

In at least one embodiment, the engine system further includes engine accessories, and the one or more operating conditions of the engine system includes one or more operating conditions of the engine accessories.

In at least one embodiment, the gearbox system includes gearbox accessories, and the one or more operating conditions of the gearbox include one or more operating conditions of the gearbox accessories. One or more operating conditions of the gearbox is the gear ratio of the gearbox.

In at least one embodiment, the equipment further includes equipment accessories, and the one or more operating conditions of the equipment includes one or more operating conditions of the equipment accessories.

In at least one embodiment, the controller is integrated within the engine system.

In at least one embodiment, the controller is integrated within the equipment.

In at least one embodiment, the engine system further comprises an aftertreatment system.

In at least one embodiment, the one or more control objectives is at least one of reducing fuel consumption of the engine, reducing noise created by the driveline, increasing the temperature of exhaust of the engine, reducing required maintenance to the driveline, increasing the life of the driveline, controlling any specific combustion parameter, or an objective set with user input.

In at least one embodiment, the gearbox is a continuously variable transmission.

In at least one embodiment, the driveline further includes a first speed sensor sensing the speed of the input of the continuously variable transmission and a second speed sensor sensing the speed of the output of the continuously variable transmission, speed data from the first and second speed sensors being supplied to the controller to allow the controller to monitor the actual speed ratio of the continuously variable transmission in real time.

In at least one embodiment, the first and second speed sensors are integrated with the continuously variable transmission.

In at least one embodiment, the first speed sensor is integrated with the engine and the second speed sensor is integrated with the load.

In at least one embodiment, the engine system is configured to communicate temperature and/or operating parameters to the controller, and the controller is configured to adjust the one or more operating conditions of one or more of the engine system, gearbox, and equipment based on the temperature and/or operating parameters of the engine.

In at least one embodiment, the gearbox is configured as to supply the controller with operation parameters of the gearbox, and the controller is configured to adjust the one or more operating conditions of one or more of the engine system, gearbox, and equipment based on the operation parameters of the gearbox.

In at least one embodiment, the engine is an internal combustion engine.

In at least one embodiment, the adjustment includes increasing the ratio of the gearbox and decreasing the speed of the engine.

In at least one embodiment, the adjustment includes decreasing the ratio of the gearbox and increasing the speed of the engine.

In at least one embodiment, the equipment is configured to supply the controller with a speed demand, and the controller is configured to adjust the one or more operating conditions of one or more of the engine system, gearbox, and equipment based on the speed demand.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of a traditional driveline;

FIG. 2 is a schematic representation of an internal combustion engine provided with an aftertreatment system.

FIG. 3 is a block diagram of an example of a driveline according to an illustrative embodiment.

FIG. 4 is a table showing experimental results of a driveline according to one embodiment.

Further aspects and features of the example embodiments described herein will appear from the following description taken together with the accompanying drawings.

### DETAILED DESCRIPTION OF THE EMBODIMENTS

The headings and Abstract of the Disclosure provided herein are for convenience only and do not impact the scope or meaning of the embodiments.

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, structural or fluidic connotation. For example, as used herein, the terms coupled or coupling can indicate that two elements or devices can be directly connected to one another or connected to one another through one or more intermediate elements or devices via a mechanical element, a structural element, a gas flow or a fluid flow depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, 10%, 15% or 20%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, 10%, 15% or 20%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

It is to be noted that the term “driveline”, used herein and in the appended claims, is to be construed as the intervening mechanism by which power is transmitted from an engine (i.e., prime mover) to a load.

One skilled in the art will understand that the engine may be, for example, an internal combustion engine or any other mechanical power production element or assembly. One skilled in the art will also understand that the load may be any load, such as but not limited to the wheels of a vehicle, a pump, a generator, etc. The driveline described herein provides a method for decoupling an engine from a load, while gathering information about the operating parameters of each component of the driveline and optimizing the operation of each component.

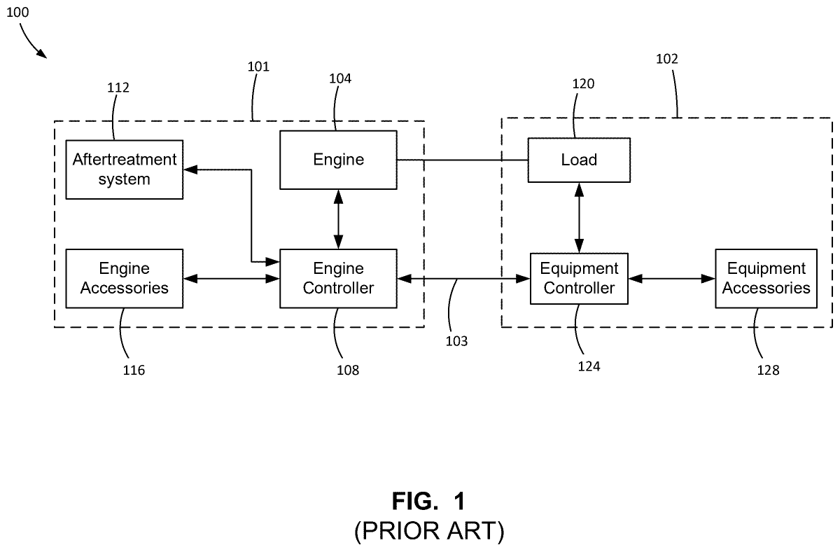

Referring to FIG. 1, shown therein is a traditional driveline 100 that has an engine system 101 connected to equipment 102. The engine system 101 includes an engine 104, an engine controller 108, an aftertreatment system 112 and optionally one or more engine accessories 116. The engine system 101 is connected to the equipment 102 via a communication network 103. The communication network 103 may be a controller area network (CAN) bus. The equipment 102 includes a load 120, an equipment controller 124 and optionally one or more equipment accessories 128. In this configuration, the rotations per minute (RPM) and torque of the engine 104 will equal the RPM and torque of the load 120. As described above, operating the engine 104 at a low load and low torque for an extended time in this configuration may create many issues, such as soot build-up, anti-pollution system blockage, anti-pollution system inefficiency for NOx emissions and part breakages.

Through the communication network 103, all components communicate and exchange information and commands in a standard format. For example, the components may exchange information regarding temperature, speed, speed settings, etc. In addition, original equipment manufacturers (OEMs) may configure the system to communicate “proprietary” messages and commands on the communication network 103. These proprietary messages manage the OEM components but are not accessible to others on the communication network 103.

The engine system 101 may broadcast various information to the communication network 103. The information may be, for example, values related to the status of the engine such as temperature. The information may also include alerts or special messages, such that the engine 104 is too cold, the engine 104 needs warm-up time, etc. The equipment 102 may receive this information from the communication network 103. The equipment 102 may then broadcast a command to the communication network 103 in response, such as “set engine RPM”, “Start”, etc, which will be picked up by the engine system 101. The engine system 101 may broadcast status messages to the communication network 103 in response, such as “engine alarms” or “standstill regeneration required within a certain time”, etc. Of course, a person skilled in the art will recognize that while the above communication scheme is described with respect to a data bus, any other device providing a communication link will meet the objectives of the present disclosure.

The aftertreatment system 112 is also known as an emission control or anti-pollution system. Such systems encompass a method or device for reducing harmful exhaust emissions from internal-combustion engines. Stated succinctly, an aftertreatment system is a device that cleans the exhaust gases to ensure that the engines meet emission regulations.

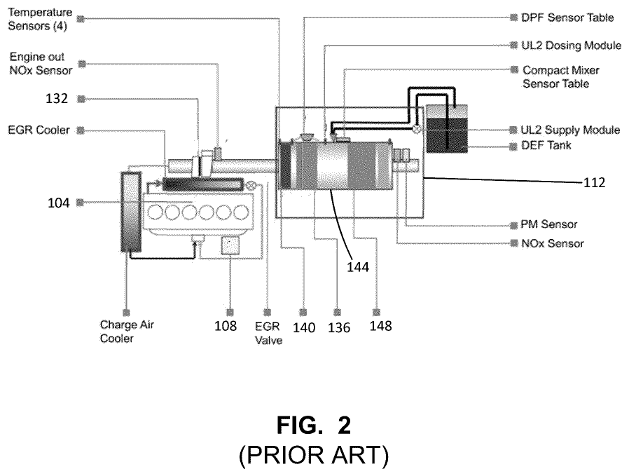

Reference is now made to FIG. 2, which shows the connection of the engine 104 to the aftertreatment system 112 and engine controller 108. Harmful emission gases from the exhaust of the engine 104 move to the aftertreatment system 112. In some cases, the exhaust of the engine 104 may pass through a turbocharger 132. The aftertreatment system 112 may include a particulate filter 136 (e.g., a diesel particulate filter). The particulate filter 136 collects and oxidizes carbon to remove particulate matter (PM) from the exhaust. Further, the aftertreatment system 112 may include an oxidation catalyst 140 (e.g., a diesel oxidation catalyst) to further increase the efficiency of the particulate filter 136. The exhaust gases may first pass through the oxidation catalyst 140, then the particulate filter 136.

After collecting the particles from the exhaust gases in the oxidation catalyst 140 and particulate filter 136, nitric oxide (NO) and nitrogen dioxide (NO2) may remain in the exhaust. In order to reduce the NOx levels, a light mist of urea, or diesel exhaust fluid (DEF) is injected into the hot exhaust stream in a decomposition reactor 144. The exhaust progresses from the decomposition reactor 144 into a selective catalytic reduction (SCR) system 148, which converts the toxic NOx and urea mixture into harmless nitrogen gas (N2) and water vapour (H20). This greatly reduces harmful emissions, resulting in near-zero emissions from the exhaust of the engine system 101.

However, such systems run effectively when the engine operates within a relatively narrow operation band, which is typically considered to be “normal” operation. Based on data obtained from engines, it has been noticed that engines such as diesel engines run for a large proportion of time outside of “normal” operating conditions. In such cases, the aftertreatment systems are ineffective, as the conditions in the aftertreatment system are not met for the chemical reactions explained above to occur, or for carbon to be burned or oxydized. Engine manufacturers use different strategies to broaden this operation band but the latter often come at the expense of efficiency.

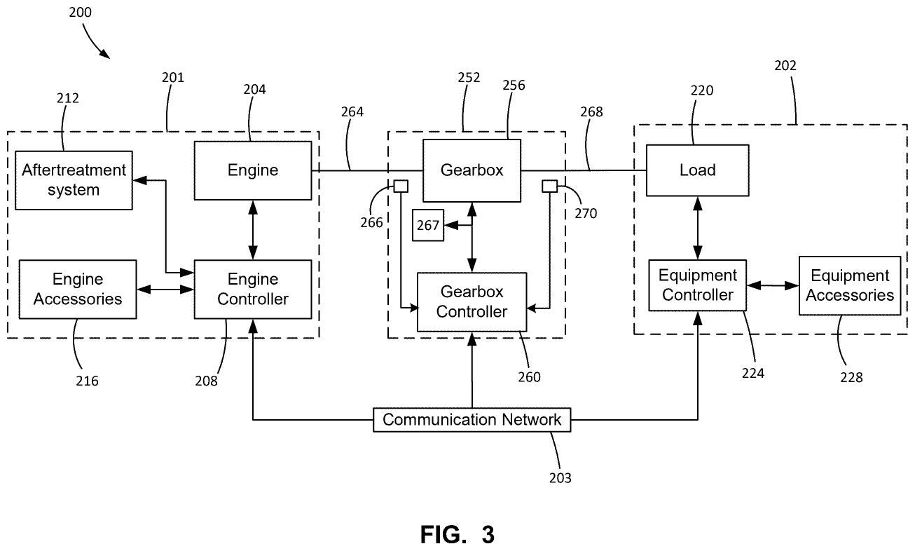

As shown in FIG. 3, the present invention is thus directed to the provision of a gearbox system 252 between an engine 204 (i.e., prime mover 204) and a load 220. FIG. 3 shows an example driveline 200 for decoupling the engine 204 from the load 220. It is to be noted that the engine 204 may be a diesel engine, gasoline engine, hydrogen engine, natural gas/propane engine, or any internal combustion engine. Many of the components shown in FIG. 3 are similar to those of FIGS. 1-2, and have reference numerals increased by 100. As shown in FIG. 3, the driveline 200 includes an engine system 201. The engine system 201 includes the engine 204, an engine controller 208, an aftertreatment system 212 and optionally one or more engine accessories 216. In some embodiments, the aftertreatment system 212 may be connected to the engine 204 in a similar manner as shown in FIG. 2. In other embodiments, the aftertreatment system 212 may be integrated with the engine 204. In other embodiments, the engine 204 is not provided with an aftertreatment system; in such cases, as will be seen below, the present disclosure contemplates collecting data regarding combustion parameters of the engine 204, and providing adjustment to these parameters.

The driveline 200 also includes equipment 202. The equipment 202 includes the load 220 as well as an equipment controller 224 and optionally one or more equipment accessories 228. The engine system 201 is connected to the equipment via communication network 203 (e.g., a CAN bus).

Between the engine system 201 and equipment 202 is the gearbox system 252. The gearbox system 252 includes a gearbox 256 as well as a gearbox controller 260. In some embodiments, the gearbox 256 includes one or more gearbox accessories. It is to be noted that the gearbox 256 may be a continuously variable transmission (CVT), including, amongst others, a toroidal CVT, a chain or belt CVT, a hydrostatic CVT, and a hydromechanics CVT, or a geared transmission, including, amongst others, powershift or automatic transmissions.

The engine controller 208, gearbox controller 260 and equipment controller 224 are all connected to the communication network 203. As with the system of FIG. 1, through the communication network 203, all components communicate and exchange information. In some embodiments, the gearbox controller 260 may be integrated with the engine system 201 (e.g., with the engine controller 208). In other embodiments, the gearbox controller 260 may be integrated with the equipment 202 (e.g., with equipment controller 224). In other embodiments, the engine controller 208, gearbox controller 260 and equipment controller 224 may all be integrated.

As explained herein, the gearbox controller 260 is in communication with the engine system 201, gearbox 256 and equipment 202, and is configured to dynamically adjust one or more operating conditions of one or more of the engine system 201, gearbox 256 and equipment 202 to satisfy one or more control objectives. More precisely, the gearbox controller is adapted to adjust the parameters in real-time, depending on the current status of the system, and in view of the current operating conditions.

In a preferred embodiment, the gearbox controller is adapted to dynamically adjust one or more operating conditions of the engine system, gearbox, and equipment based on real-time data from a plurality of sensors, including at least a speed sensor and a temperature sensor. The operating conditions of at least one of the engine system, gearbox and equipment are controlled to optimize the performance of an aftertreatment system by maintaining engine operating conditions within a predefined optimal range. Specific control objectives, including reducing fuel consumption, minimizing emissions, and enhancing driveline efficiency, are achieved through the described control strategy that integrates user-defined parameters and environmental conditions.

The engine system 201 may broadcast various data related to the engine system 201 to the communication network 203. For example, this data could include data collected by various sensors and timers regarding the current state of the engine 204 (e.g., temperature sensors, NOx sensors, DPF sensors, PM sensor, etc.). The gearbox controller 260 is adapted to collect this data from communication network 203. The equipment system may also broadcast data related to its requirements to the communication network 203. The gearbox controller 260 further is adapted to capture these requirements of the equipment 202. Based on data obtained from the equipment 202 and/or engine system 201, the gearbox controller 260 may control the gearbox 256. In particular, the gearbox controller 260 may adjust the gear ratio of the gearbox 256.

The combination of the gearbox 256 and the gearbox controller 260 effectively permit a decoupling of the load 220 from the engine 204 through the gearbox 256. Thus, notwithstanding the demands of the load 220 on the engine 204, the gearbox 256 and the gearbox controller 260 ensure that the operating conditions of the engine system 201 remain, as much as possible, within the “normal” operating conditions, or are able to dynamically adjust the demands on the engine 204 without affecting the power transmitted to the load 220. Advantageously, this embodiment permits triggering the functioning of the aftertreatment system 212 to further reduce the emissions produced by the engine 204.

The input of the gearbox 256 is connected to the output of the engine 204 via a first shaft 264. The speed of the first shaft 264 is measured via a first speed sensor 266. The output of the gearbox 256 is connected to the load 220 via a second shaft 268. The speed of the second shaft 268 is measured via a second speed sensor 270. One skilled in the art will understand that the block diagram of FIG. 3 is schematic and that many other elements, required for the operation of the driveline 200 have been omitted therefrom. The gearbox 256 is able to decouple the engine 204 from the load 220, such that the operating conditions of the load 220 do not need to be imposed onto the engine 204.

The gearbox controller 260 may also adjust the operating conditions of the engine accessories 216 and/or equipment accessories 228. These accessories may include but are not limited to fans, alternators or generators, valves, batteries, etc. For example, the engine accessories 216 may include a fan, and the speed of the fan may be increased by the gearbox controller 260. Increasing the speed of the fan lowers the temperature of the engine 204.

For certain equipment 202, the gearbox controller 260 may also interact with equipment 202 to better control the engine system 201 parameters. For example, if equipment 202 is a compressor, the gearbox controller 260 may create a restriction thanks to the compressor's throttling valve 228 (i.e., the throttling valve is an example of an equipment accessory 228), which chokes the system and increases the load. If the equipment 202 is a generator, the gearbox controller 260 may activate the generator's load bank 228 to increase the load (i.e., the load bank is another example of an equipment accessory 228).

The gearbox controller 260 may use a variety of information, which is usually accessible via the communication network 203 (e.g., CAN bus). The information the gearbox controller 260 may use includes information about the engine system 201, including temperature (e.g., of the exhaust and anti-pollution subsystems, ambient temperature, and coolant temperature), operating parameters (e.g., mass air flow, exhaust restriction, soot level, ash level, operating status (i.e., passive regeneration, active regeneration or standstill regeneration), percent load, speed, fuel consumption, exhaust fluid consumption, and exhaust fluid condition, such as level, temperature and condition), and different counters (e.g., time spent outside normal conditions, time spent at low speed, time since last fuel fluid injections, etc.). The gearbox controller 260 may also use information about the gearbox 256, including information about its speed (e.g., at its input and output), temperature and pressure (e.g., of the oil).

The driveline 200 may operate in the following manner. The equipment controller 224 will send a speed request message to the network 203, which will be picked up by the gearbox system 252 (rather than the engine system 201, as with the system of FIGS. 1-2). The gearbox controller 260 will provide to the equipment 202 via the network 203 the appropriate RPM based on the RPM setting of the received speed request message. Based on the operating parameters of the engine system 201 that are broadcasted on the communication network 203, the gearbox controller 260 will decide at which RPM the engine 204 should operate as a function of the control objective. Having the required RPM setting of the load 220 and the optimal RPM of the engine 204, the gearbox controller 260 will calculate the ratio of the gearbox 256 that needs to be set in order to match the RPM of the engine 204 to the required RPM of the load 220 (engine RPM*Ratio=RPM setting required by load).

As will be easily understood by one skilled in the art, the first speed sensor 266 could be integrated with the engine system 201 or both the first and second speed sensors 266, 270 could be integrated with the gearbox 256. The second speed sensor 270 could be integrated with the equipment 202.

The gearbox controller 260 may adjust the operating conditions of the engine system 201, gearbox 256, and/or equipment 202 in order to satisfy a control objective. The control objectives may include but are not limited to reducing fuel consumption, reducing noise, increasing the exhaust temperature, reducing required maintenance, minimizing detrimental exhaust gases and increasing the life of any components of the driveline 204 (e.g., the engine 204, gearbox 256, or load 220). Other control objectives may be desired depending on the situation and/or user input.

As a non-limiting example, the temperature of the exhaust of the engine 204 may be too cold such that the soot level in the aftertreatment system 212 is at a critical level and rapidly rising. The gearbox controller 260 will then take action to lower the speed of the engine 204 (which increases the torque) and increase the ratio of the gearbox 256 in order to maintain the rotational speed at the output of the gearbox 256 (i.e., the speed measured by the second speed sensor 270) at a requested setpoint. The increase in torque causes the exhaust temperature to rise, which causes the soot level of the aftertreatment system 212 to drop.

As another non-limiting example, the engine 204 may have been running for a long period with low exhaust temperature, and therefore may have not injected exhaust fluid for a significant amount of time. The exhaust fluid is then at risk of crystallizing. The gearbox controller 260 will then take action to promote conditions where exhaust fluid would be injected. At the end of this cycle, the gearbox controller 260 resumes operation as per other control objectives.

As another non-limiting example, the engine 204 may have been running for a long period of time at low power, and therefore could be producing harmful gases such as NOx and CO. The gearbox controller 260 will then take action to reduce the harmful emissions by balancing the engine mass airflow, NOx production and exhaust temperature.

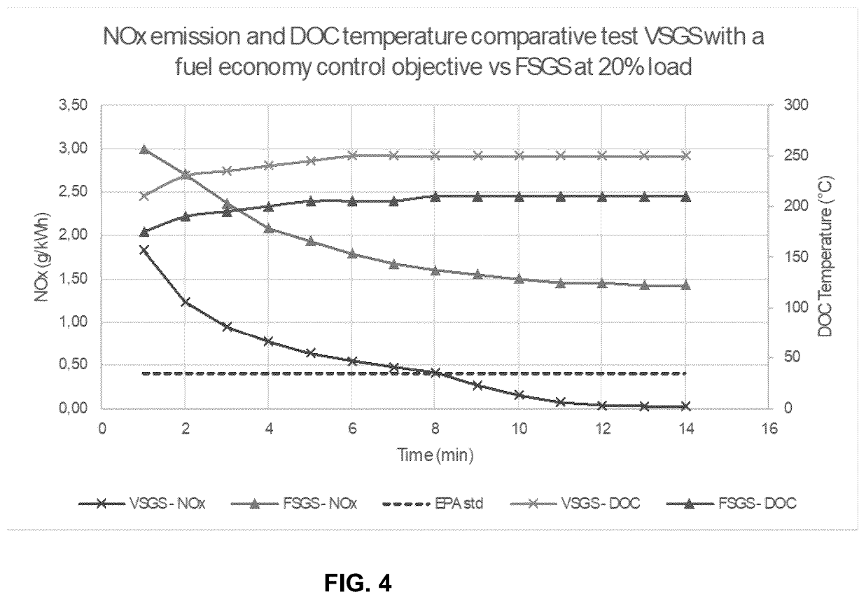

Referring now to FIG. 4, there is shown a graph of NOx emissions and DOC temperatures as a function of time, illustrating the significant improvements provided by the system and method described herein. In this graph, VSGS is the variable speed genset, FSGS is the fixed speed genset. NOx is the measure of NOx emissions, while DOC is the temperature of the Diesel Oxydation Catalyst. The DOC converts CO and hydrocarbons into CO2 and water when the temperature is between 400° C. and 1206° F. The DOC temperature is related to the injection of DEF. The DEF reacts with NOx in the SCR to produce water and nitrogen. The results were obtained using an Isuzu™ diesel motor, tested in open space with an identical load bank in similar operating conditions. The VSGS-NOx line clearly shows significantly decreased NOx emissions after about 8 minutes of run-time (the dashed line across the graph is current Environmental Protection Agency (EPA) standard recommendations, while insuring a relatively stable temperature at a constant 20% load.

Although the above three? examples are specific to diesel engines, the adjustment of the operating parameters by the gearbox controller 260 is also feasible for machines powered by other fuels.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A driveline comprising:
an engine system comprising an engine, the engine having an output shaft;
a gearbox having a gearbox input connected with the output shaft of the engine and a gearbox output;
an equipment comprising a load, the load having a load input connected with the gearbox output; and
a controller in communication with the engine system, gearbox and equipment, the controller configured to dynamically adjust one or more operating conditions of one or more of the engine system, gearbox, and equipment to satisfy one or more control objectives.

2. The driveline of claim 1, wherein the one or more operating conditions of the engine system comprises the speed of the engine.

3. The driveline of claim 1, wherein the engine system further comprises engine accessories, and wherein the one or more operating conditions of the engine system comprises one or more operating conditions of the engine accessories.

4. The driveline of claim 1, therein the gearbox system further includes at least one gearbox accessory, and wherein the one or more operating conditions of the gearbox includes at least one of one or more operating conditions of the equipment accessories and the gear ratio of the gearbox.

5. The driveline of claim 1, wherein the equipment further comprises equipment accessories, and the one or more operating conditions of the equipment comprises one or more operating conditions of the equipment accessories.

6. The driveline of claim 1, wherein the controller is integrated within the engine system.

7. The driveline of claim 1, wherein the controller is integrated within the equipment.

8. The driveline of claim 1, wherein the engine system further comprises an aftertreatment system.

9. The driveline of claim 1, wherein the one or more control objectives is at least one of reducing fuel consumption of the engine, reducing noise created by the driveline, increasing the temperature of exhaust of the engine, reducing required maintenance to the driveline, increasing the life of the driveline, reducing NOx or CO or both, emissions, controlling any specific combustion parameter, or an objective set with user input.

10. The driveline of claim 1, wherein the gearbox is a continuously variable transmission.

11. The driveline of claim 10, further comprising a first speed sensor sensing the speed of the input of the continuously variable transmission and a second speed sensor sensing the speed of the output of the continuously variable transmission, speed data from the first and second speed sensors being supplied to the controller to allow the controller to monitor the actual speed ratio of the continuously variable transmission in real time.

12. The driveline of claim 11, wherein the first and second speed sensors are integrated with the continuously variable transmission.

13. The driveline of claim 11, wherein the first speed sensor is integrated with the engine and the second speed sensor is integrated with the load.

14. The driveline of claim 1, wherein the engine system is configured to communicate temperature and/or operating parameters to the controller, and the controller is configured to adjust the one or more operating conditions of one or more of the engine system, gearbox, and equipment based on the temperature and/or operating parameters of the engine.

15. The driveline of claim 1, wherein the gearbox is configured as to supply the controller with operation parameters of the gearbox, and the controller is configured to adjust the one or more operating conditions of one or more of the engine system, gearbox, and equipment based on the operation parameters of the gearbox.

16. The driveline of claim 1, wherein the engine is an internal combustion engine.

17. The driveline of claim 1, wherein the adjustment comprises increasing the ratio of the gearbox and decreasing the speed of the engine.

18. The driveline of claim 1, wherein the adjustment comprises decreasing the ratio of the gearbox and increasing the speed of the engine.

19. The driveline of claim 1, wherein the equipment is configured to supply the controller with a speed demand, and the controller is configured to adjust the one or more operating conditions of one or more of the engine system, gearbox, and equipment based on the speed demand.
